(19) United States
(12) Patent Application Publication
(10) Pub. No.: US 2005/0281156 A1
(43) Pub. Date: Dec. 22, 2005

(54) Optical information recording/reproducing apparatus capable of detecting timing to interrupt recording or reproducing

(75) Inventor: Fumito Watanabe, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/147,188

(22) Filed: Jun. 8, 2005

(30) Foreign Application Priority Data
Jun. 21, 2004 (JP) 2004-182531

(51) Int. Cl. G11B 7/00; G11B 5/09

(52) U.S. Cl. 369/47.11; 369/44.25; 369/47.55; 369/53.45

(57) ABSTRACT

There is disclosed an optical information recording/reproducing apparatus capable of exactly detecting a timing to interrupt recording or reproducing. A threshold value is set with respect to a state detection signal (parameter) indicating an irradiation state with an optical disk 1 such as a focus error signal and a tracking error signal, and the recording or reproducing is interrupted in accordance with a comparison result of the state detection signal with the threshold value. The threshold value set with respect to one state detection signal is set in accordance with another state detection signal.

### BACKGROUND OF THE INVENTION

1. Field of the Invention

The present invention relates to an optical information recording/reproducing apparatus which records or reproduces data with respect to an optical recording medium, particularly to a technique for recording/reproducing data without deteriorating a signal quality level of the data, even when disturbances such as vibration and shock are added to the apparatus.

2. Description of the Related Art

As an optical disk drive using an optical recording medium, a large number of devices have heretofore been proposed each comprising: a memory (hereinafter referred to as a shock-proof memory) in which data is temporarily stored. Each device intermittently records/reproduces data with respect to an optical disk in such a manner that the data can be recorded/reproduced without being interrupted even when disturbances such as vibration and shock are added to the apparatus. This is proposed, for example, in Japanese Patent Application Laid-Open No. 08-007287.

FIG. 10 is a diagram showing an optical disk drive which records/reproduces data using this conventional shock proof memory.

First, an optical disk 1, coupled to a driver 2, is irradiated with laser light from a pickup 3, and reflected light enters a sensor (not shown) in the pickup 3. In response to incident light on the sensor, signals are input into a focus error generation circuit 4 and a tracking error generation circuit 7, and a focus error signal and a tracking error signal which are outputs are subjected to a phase compensation process by phase compensation filters 5 and 8. In response to outputs of the phase compensation filters 5, 8, a focus actuator driver 6 and a tracking actuator driver 9 drive an actuator (not shown) in the pickup 3, and focus tracking control is executed in such a manner that the laser light is focused on a desired track in the optical disk 1.

To reproduce the data, after focusing the laser light on the desired track, the data from the optical disk 1 starts to be read. The data read from the optical disk 1 is stored once in a shock-proof memory 10 via a signal processing circuit (not shown). Thereafter, when a data amount in the shock-proof memory 10 is not less than a predetermined value, the reading of the data from the optical disk 1 is once interrupted. The data in the shock-proof memory 10 is input into a decoder 11, and the decoder 11 converts the data from the shock-proof memory 10 into a sound or image signal or the like to output a reproducing signal. When the data amount in the shock-proof memory 10 is not more than a predetermined value, the reading of the data from the optical disk 1 is resumed.

Next, to record the data, first a recording signal of light or sound data detected by a CCD or microphone (not shown) is converted into a data string in accordance with a recording format into the optical disk 1 by an encoder 12. The recording data is once stored in the shock-proof memory 10. When a data amount in the shock-proof memory 10 is not less than the predetermined value, the laser light is focused on the desired track of the optical disk 1, and the recording data in the shock-proof memory 10 is recorded in the optical disk 1.

While the data is recorded into the optical disk 1, the tracking error signal is input into a tracking error monitoring circuit 13. A threshold value is set to the tracking error monitoring circuit 13 with respect to a tracking error signal level, and the threshold value has a size corresponding to a signal, for example, in a case where the laser light is positioned between the tracks. When the tracking error signal level exceeds the threshold value, the tracking error monitoring circuit 13 outputs a recording stop signal to a controller 14. When the recording stop signal is input, the controller 14 lowers a laser output in order to stop the recording of the data into the optical disk 1, and an objective lens (not shown) in the pickup 3 is disposed away from the optical disk 1.

Thereafter, the focus tracking control is performed in such a manner as to focus again the laser light on the desired track in the optical disk 1, and the recording is stopped to thereby restart the recording of the data which cannot be normally recorded. The recording data output from the encoder 12 is stored in the shock-proof memory 10 from when the recording is stopped to perform the tracking control until the recording is restarted. Therefore, the recording data is not interrupted, and the data can be prevented from being recorded in a track adjacent to a track in which the data has to be originally recorded by shock.

Even while the data is read from the optical disk 1, the tracking error monitoring circuit 13 monitors the tracking error signal level. When it is detected that the tracking control has deviated, a reproducing stop signal is output to the controller 14. When the reproducing stop signal is input, the controller 14 keeps the objective lens (not shown) in the pickup 3 away from the optical disk 1 in order to stop a data reading operation from the optical disk 1.

Thereafter, the focus tracking control is performed in such a manner as to focus again the laser light on the desired track in the optical disk 1, and the data restarts to be read from the optical disk 1. The data stored in the shock-proof memory 10 is output to the decoder 11 from when the reading of the data from this optical disk 1 is stopped to perform the focus tracking control until the reading is restarted. Therefore, the reproducing data is not interrupted, even if shock is added to the optical disk drive.

In the optical disk drive in which the recording or reproducing data is temporarily stored in the shock-proof memory 10 as described above, the tracking error signal is monitored to detect a timing to stop a recording or reproducing operation, accordingly the recording or reproducing data is prevented from being interrupted, and the data is prevented from being overwritten by mistake.

In the conventional optical disk drive, a threshold value is a fixed value with respect to the tracking error signal indicating that a tracking deviation. There is also a method in which a threshold value is set with respect to the tracking error signal or a sum signal level in such a manner that the quality level of the recording or reproducing signal is predicted to be not more than a predetermined value, and the recording/reproducing is stopped. However, the threshold value to be set with respect to the tracking error signal or the sum signal level is merely set independently with respect to each signal.

Problems arise in a case where a signal is independently monitored in order to detect a timing to stop the recording/reproducing in this manner, such as the tracking error signal, the sum signal or the like.

For example, when the timing to stop the recording/reproducing is detected with reference to the tracking error signal only, that signal relates to a de-track amount with respect to the optical disk of the laser light. In this case, a certain threshold value is set as the de-track amount to stop recording/reproducing, and a timing to stop recording/reproducing is measured. Then, even when the de-track amount exceeds the threshold value, the signal quality level does not fall in such a manner as to stop recording/reproducing in a case where there is not any defocus amount.

Conversely, even when the de-track amount does not exceed the threshold value, the signal quality level sometimes falls in such a manner as to stop recording/reproducing depending on the defocus amount at this time. When there is only one signal to be monitored in order to detect the timing for stopping recording/reproducing in this manner, or the threshold value to be set with respect to the signal is the fixed value, the timing to stop the recording/reproducing operation cannot be exactly detected.

When the timing to stop recording/reproducing cannot be exactly detected, for example, an ECC process is performed in order to simply reproduce data indicating the signal quality level which should be originally stopped during reproduction. Then, since the data quality level has an error frequency that cannot be corrected by the ECC, it cannot be clarified that there is data whose reproduction is to be stopped until the ECC process is performed. In this case, the tracking control is again performed with respect to the track having a bad signal quality level, and the data has to be read again. Therefore, time is wasted, and the reproducing data is interrupted in a worst case.

Moreover, when a timing to interrupt the recording cannot be exactly detected during the recording, the data having an error frequency that cannot be corrected by the ECC process is sometimes recorded in the disk. Furthermore, when recording/reproducing is stopped by such a servo difference that the recording/reproducing operation does not have to be originally stopped during the recording/reproducing, there has been a problem that power consumption is wasted for performing again the focus tracking control with respect to the track after stopping the recording/reproducing.

### SUMMARY OF THE INVENTION

According to the present invention, there is provided an optical information recording/reproducing apparatus capable of exactly detecting a timing to interrupt recording or reproducing.

The optical information recording/reproducing apparatus of the present invention is an optical information recording/reproducing apparatus which records or reproduces information using a light beam, including the following:

a circuit which outputs a plurality of state detection signals in accordance with an irradiation state of the light beam; and

a circuit which distinguishes deviation from a desired irradiation state of the light beam based on a comparison result of the plurality of state detection signals with a threshold value set with respect to each signal to stop a recording or reproducing operation,

wherein the threshold value set with respect to one state detection signal is set in response to another state detection signal.

Further features and advantages of the present invention will become apparent from the following description of exemplary embodiments (with reference to the attached drawings).

### BRIEF DESCRIPTION OF THE DRAWINGS

FIG. 1 is a block diagram showing a first embodiment of an optical information recording/reproducing apparatus according to the present invention;

FIG. 2 is a flowchart showing a recording/reproducing interrupt distinction process of the first embodiment;

FIG. 3 is a graph showing a method of setting a recording/reproducing interrupt condition of the first embodiment;

FIG. 4 is a graph showing an effect of the first embodiment;

FIG. 5 is a block diagram showing a second embodiment of the present invention;

FIG. 6 is a flowchart showing a recording/reproducing interrupt distinction process of the second embodiment;

FIG. 7 is a graph showing a method of setting a recording/reproducing interrupt condition of the second embodiment;

FIG. 8 is a block diagram showing a third embodiment of the present invention;

FIG. 9 is a flowchart showing a recording/reproducing interrupt distinction process of the third embodiment; and

FIG. 10 is a block diagram showing an optical disk drive according to a conventional example.

### DESCRIPTION OF THE EMBODIMENTS

Next, a best mode for carrying out the present invention will be described in detail with reference to the drawings.

### First Embodiment

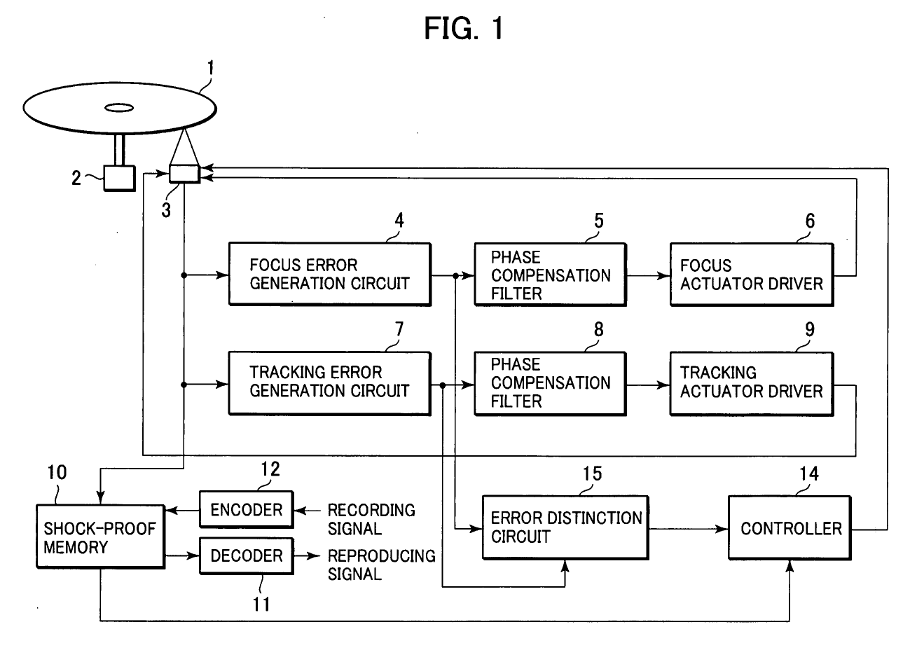

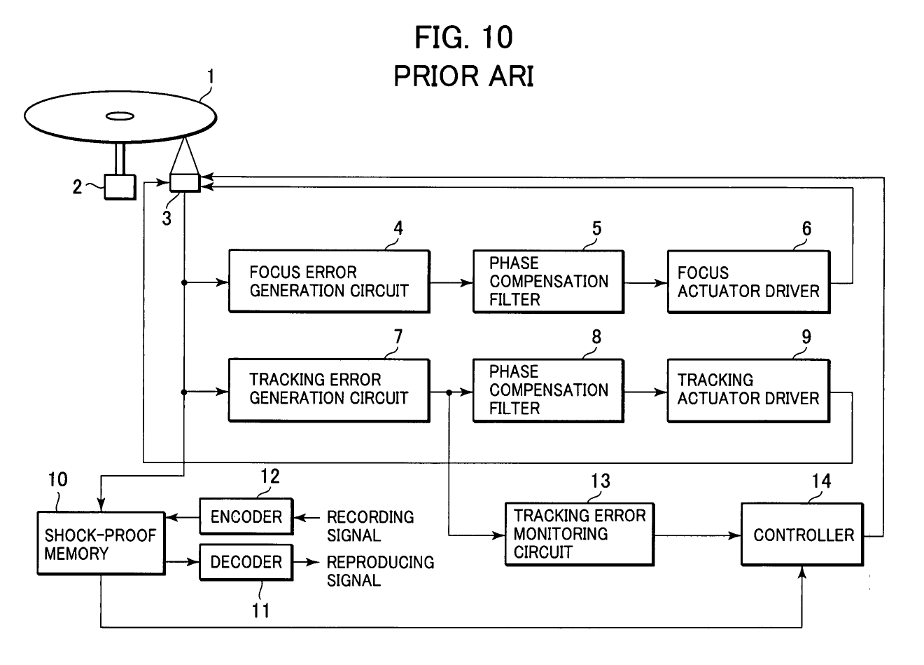

FIG. 1 is a block diagram showing a constitution of a first embodiment of an optical information recording/reproducing apparatus according to the present invention. In FIG. 1, blocks having the same functions as those of a conventional apparatus shown in FIG. 10 are denoted with the same reference numerals, and the description is omitted. Also in the present embodiment, to record or reproduce data, recording or reproducing data is first stored in a shock-proof memory 10. When a recording data amount in the shock-proof memory 10 is not less than a predetermined value, or a reproducing data amount is not more than a predetermined value, a focus tracking control is performed with respect to a desired track in an optical disk 1 to record or read the data with respect to the optical disk 1.

When the data is recorded or read with respect to the optical disk 1, both a focus error signal and a tracking error signal are input into an error distinction circuit 15. The reference to both the focus error signal and the tracking error signal relates to both a defocus amount and a de-track amount of laser light with respect to the optical disk 1. When the defocus amount and the de-track amount are generated in such a manner that a recording or reproducing data quality level is predicted to drop below the predetermined value, the error distinction circuit 15 outputs a recording/reproducing stop signal to the controller 14. In response to the recording/reproducing stop signal, the controller 14 lowers a laser output, and stops a recording or reading operation with respect to the optical disk 1.

After stopping the recording or reading operation with respect to the optical disk 1, the controller 14 performs the focus tracking control in such a manner as to focus light on a track in the optical disk 1 with respect to which the recording or reading operation has been stopped, and the controller restarts the recording or reading operation of the data with respect to the optical disk 1. The recording data being recorded is stored in the shock-proof memory 10 from when the recording or reading operation is stopped with respect to the optical disk 1 until the operation is restarted. Alternatively, during the reproducing, the data is reproduced using the reproducing data stored in the shock-proof memory 10.

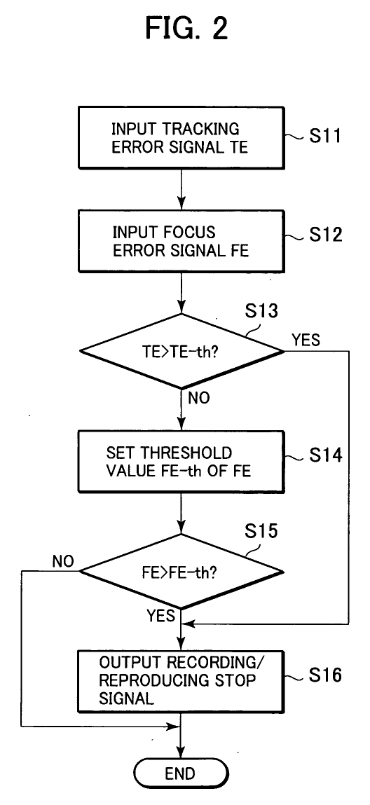

Next, an operation of the error distinction circuit 15 will be described with reference to a flowchart of FIG. 2. First, a tracking error signal TE and a focus error signal FE are input into the error distinction circuit 15 (S11 and S12). Next, a tracking error signal level is compared with a threshold value TE-th (S13). The threshold value TE-th is set to a tracking error signal level to stop recording/reproducing irrespective of a magnitude of the focus error signal level, that is, a defocus amount (even if the defocus amount is 0).

When the tracking error signal level TE is not less than TE-th, the error distinction circuit 15 instantaneously outputs a recording/reproducing stop signal to the controller 14 (S16). When the tracking error signal level is less than TE-th, a threshold value FE-th is next set with respect to the focus error signal level to interrupt the recording/reproducing based on the tracking error signal level (S14).

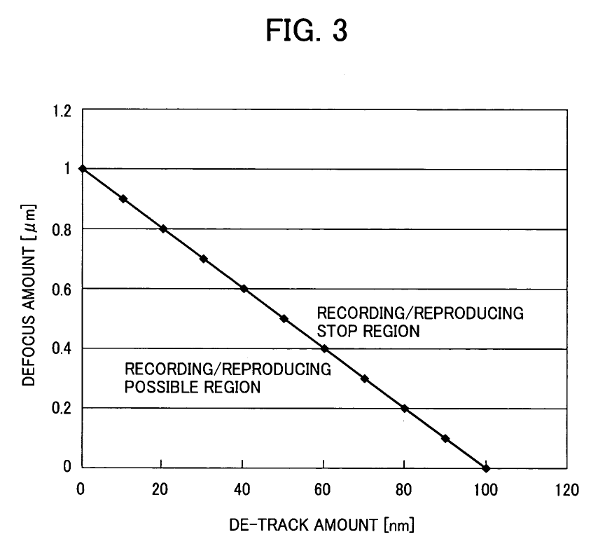

A method of setting FE-th will be described with reference to FIG. 3. The abscissa indicates a de-track amount, and the ordinate indicates a defocus amount. In two regions separated by a line in the figure, an upper right region shows a combination of the de-track amount and the defocus amount to stop the recording/reproducing operation. Conversely, a lower left region shows a combination of the de-track amount and the defocus amount to such an extent that the recording/reproducing does not have to be stopped. That is, for example, when the tracking error signal level corresponds, for example, to 40 nm in terms of the de-track amount, the defocus amount to stop the recording/reproducing operation is set to 0.6 μm, and a threshold value corresponding to the defocus amount is set with respect to the focus error signal level.

That is, when the de-track amount is 40 nm, and the defocus amount is 0.6 μm or more with reference to the tracking error signal, the recording/reproducing operation is stopped. Even when the de-track amount is 40 nm, the recording/reproducing is not stopped as long as the defocus amount is 0.4 μm. On the other hand, when the de-track amount is 60 nm, and the defocus amount is 0.4 μm or more, recording/reproducing is stopped. When both the focus error signal and the tracking error signal are monitored, and a relation between two signals satisfies, for example, equation (1), recording/reproducing is stopped to thereby detect a timing to stop the recording/reproducing operation.
i K_{T}·D_{T}+D_{F}≧K_{T}·D_{T}+1 μm (1),
wherein K_{T} denotes a coefficient of the de-track amount, D_{T} denotes the de-track amount, and D_{F} denotes the defocus amount.

The threshold value FE-th set with respect to the focus error signal level based on the tracking error signal level may be calculated based on the equation (1), or the threshold value FE-th of the focus error signal level corresponding to the tracking error signal level may be prepared from a table. A method will be described in which FE-th is obtained based on a condition for stopping the recording/reproducing operation as shown in FIG. 3 and using the equation (1). When K_{T}=−10 from a tilt of a straight line in FIG. 3, and, for example, D_{T}=40 nm, these values are substituted into the equation (1), and then a condition to interrupt the recording/reproducing at a time when the de-track amount is 40 nm is as follows:
D_{F}≧0.6 μm (2).
Then, FE-th=0.6 μm.

Next, the focus error signal level is compared with the threshold value FE-th set as described above (S15). At this time, when the focus error signal level is not less than FE-th, the error distinction circuit 15 outputs the recording/reproducing stop signal (S16).

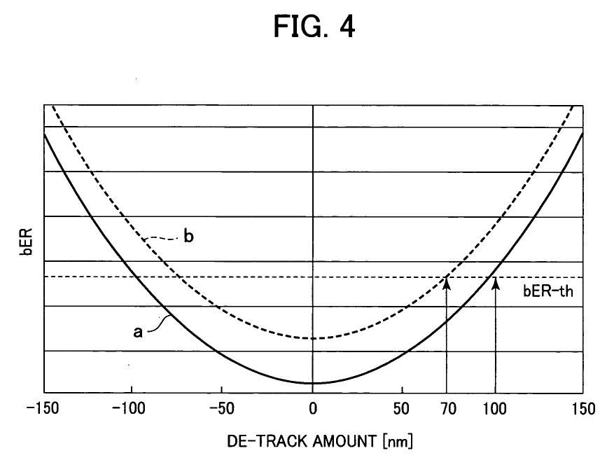

An effect will be described with reference to FIG. 4. The effect results from determining a condition for interrupting the recording/reproducing by combining the focus error signal level and the tracking error signal level as in the present embodiment. The abscissa indicates a de-track amount, and the ordinate indicates a reproducing signal bER in a case where recording or reproducing is performed in the de-track amount. It is also assumed that a value of bER to interrupt recording or reproducing is bER-th. In the figure, a curve a shows a characteristic of bER with respect to the de-track amount at a time when the focus error signal level is FE-a (it is assumed here that the defocus amount corresponding to FE-a is 0.1 μm).

In the characteristic, the de-track amount to interrupt the recording or reproducing is 100 nm. On the other hand, a curve b shows a characteristic of bER with respect to the de-track amount at a time when the focus error signal level is FE-b (it is assumed here that the defocus amount corresponding to FE-b is 0.5 μm). In the characteristic, the de-track amount to interrupt recording or reproducing is 70 nm.

Even when the de-track amount is similarly 70 nm in this manner, but when the defocus amount is 0.1 μm, recording or reproducing does not have to be interrupted. However, when the defocus amount is 0.5 μm, recording or reproducing needs to be interrupted. That is, after detecting the de-track amount from the tracking error signal level, the threshold value of the focus error signal level to interrupt recording or reproducing is set from the de-track amount, so that a timing to interrupt recording or reproducing can be exactly detected.

Moreover, when the signal levels of both the focus error signal and the tracking error signal are monitored as in the present embodiment, an appropriate timing to stop recording/reproducing can be detected. Since the timing to stop recording/reproducing can be exactly detected with reference to two signals: the focus error signal; and the tracking error signal, recording/reproducing is not uselessly interrupted, and power consumption required for a recovery process of the interruption is not generated.

Furthermore, the apparatus may be constituted in such a manner that the deposition of means for detecting temperature in the optical disk drive, and the calculating or setting of the threshold value with respect to the tracking error signal and the focus error signal, is changed in accordance with a detection result of the temperature. Additionally, the apparatus may be constituted in such a manner that the deposition of means for detecting reflectance of the optical disk from the focus or tracking error signal level, and the calculating or setting of the threshold value with respect to the tracking error signal and the focus error signal, is changed in accordance with a detection result of the reflectance.

### Second Embodiment

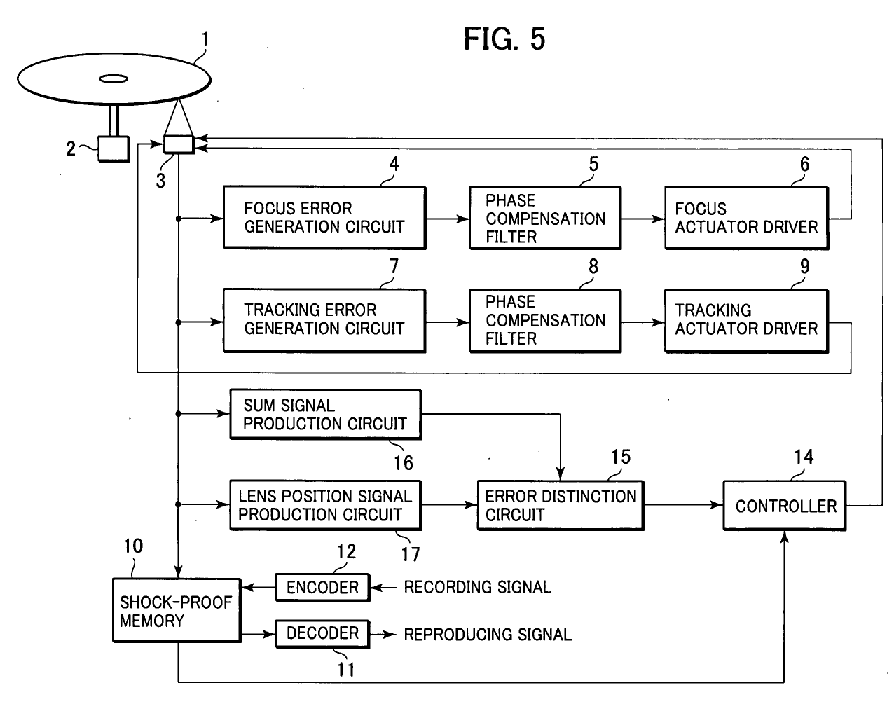

FIG. 5 is a block diagram showing a second embodiment of the present invention. In FIG. 5, blocks having the same functions as those of the conventional apparatus of FIG. 10 and the first embodiment of FIG. 1 are denoted with the same reference numerals. Also in the present embodiment, to record or reproduce data, recording or reproducing data is stored in a shock-proof memory 10. When a recording data amount in the shock-proof memory 10 is not less than a predetermined value, or a reproducing data amount is not more than a predetermined value, a focus tracking control is performed with respect to a desired track in an optical disk 1 to record or read the data with respect to the optical disk 1.

Moreover, a sum signal production circuit 16 produces a sum signal corresponding to a sum of a reflected light quantity from the optical disk 1. A lens position signal production circuit 17 produces a lens position signal indicating a relative position of a carriage (not shown) in the pickup 3 with respect to an objective lens. That is, the lens position signal is a signal indicating the position of the objective lens in a tracking direction, and is detected based on an output of a lens position sensor.

When data is recorded or reproduced with respect to the optical disk 1, both a sum signal and a lens position signal are input into an error distinction circuit 15. In case of generation of a sum signal level and a lens position signal by which it is predicted that a recording or reproducing data quality level drops below a predetermined value, the error distinction circuit 15 outputs a recording/reproducing stop signal to a controller 14. The controller 14 lowers a laser output in response to the recording/reproducing stop signal to stop a recording or reading operation with respect to the optical disk 1.

After stopping the recording or reading operation with respect to the optical disk 1, the controller 14 performs a focus tracking control in such a manner as to focus the light on a track with respect to which the recording or reading operation has been stopped, and the recording or reading operation is restarted with respect to the optical disk 1. From when the recording or reading is stopped with respect to the optical disk 1 until it is restarted, the recording data which has been recorded in the optical disk 1 is stored in the shock-proof memory 10. The data which has been read from the optical disk 1 is reproduced using the data stored in the shock-proof memory 10.

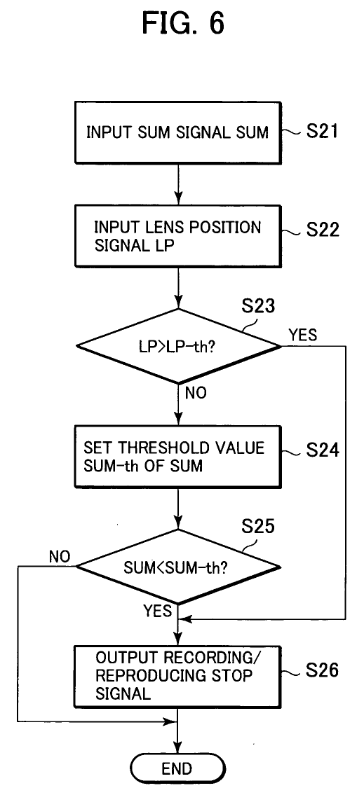

Next, an operation of the error distinction circuit 15 will be described with reference to a flowchart of FIG. 6. First, a sum signal SUM and a lens position signal LP are input into the error distinction circuit 15 (S21 and S22). Next, a lens position signal level is compared with a threshold value LP-th (S23). The threshold value LP-th is set to the lens position signal level at which the recording/reproducing operation is to be stopped irrespective of a sum signal level. When the lens position signal level is not less than LP-th, the error distinction circuit 15 instantaneously outputs a recording/reproducing stop signal to the controller 14.

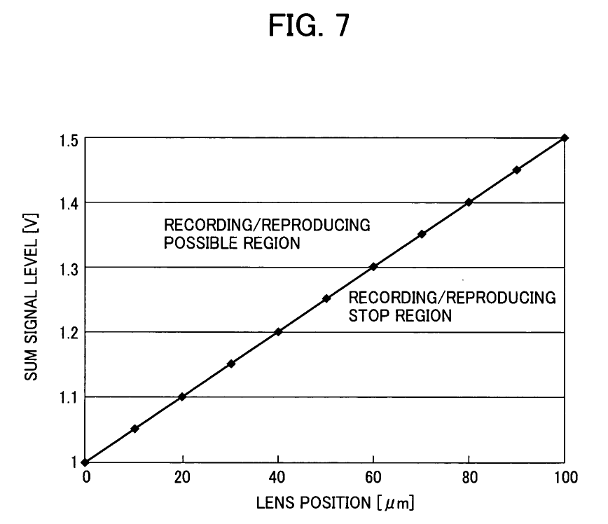

When the lens position signal level is not more than LP-th, a threshold value SUM-th is set with respect to the sum signal level at which the recording/reproducing operation is to be interrupted based on the lens position signal level (S24). A method of setting SUM-th will be described with reference to FIG. 7. In FIG. 7, the abscissa indicates an objective lens position, and the ordinate indicates a sum signal level. In two regions separated by a line in the figure, a lower right region shows a combination of a lens position and a sum signal level to stop the recording/reproducing. Conversely, an upper left region shows a combination of a lens position and a sum signal level to such an extent that the recording/reproducing does not have to be stopped.

That is, when the lens position corresponds, for example, to 60 μm with respect to an optical center in terms of the lens position signal level, the sum signal level to stop the recording/reproducing operation corresponds to 1.3 V. When the lens position is 40 μm, and a sum signal level is 1.2 V or less with reference to the lens position signal, the recording/reproducing operation is stopped. Even when the lens position is 40 μm, but when the sum signal level is 1.25 V, the recording/reproducing operation does not stop. On the other hand, when the lens position is 60 μm, and the sum signal level is 1.25 V, the recording/reproducing operation is stopped. After setting SUM-th, the sum signal level is compared with SUM-th (S25). When the sum signal level is not more than SUM-th, a recording/reproducing/stopping signal is output (S26).

When the signal levels of both the lens position signal and the sum signal are monitored as in the present embodiment, an appropriate timing to stop the recording/reproducing can be detected. Since the timing to stop the recording/reproducing operation can be exactly detected referring to two signals: the lens position signal; and the sum signal, the recording/reproducing operation is not uselessly interrupted, and power consumption required for a recovery process for the interruption is not generated. Furthermore, since the threshold value is set with respect to the sum signal level by the lens position signal, the timing to stop the recording/reproducing operation can be exactly detected while handling change of a signal level by the lens position, that is, change of an optical performance of the pickup. The threshold value SUM-th to be set with respect to the sum signal level based on the lens position signal level may be calculated, or the threshold value SUM-th of the sum signal level corresponding to the lens position signal level may be prepared from a table.

Furthermore, the apparatus may be constituted in such a manner that the disposition of means for detecting temperature in the optical disk drive, and the calculating or setting of the threshold value with respect to the lens position signal and the sum signal, is changed in accordance with a detection result of the temperature. Additionally, the apparatus may be constituted in such a manner that the deposition of means for detecting reflectance of the optical disk from the sum signal level, and the calculating or setting of the threshold values with respect to the lens position signal and the sum signal, is changed with temperature in accordance with a detection result of the reflectance.

Moreover, in the present embodiment, a condition for stopping the recording/reproducing operation has been set by the combination of the lens position signal and the sum signal, but the condition for storing the recording/reproducing operation may be set by combination of the lens position signal and focus error signal, or the lens position signal and tracking error signal.

### Third Embodiment

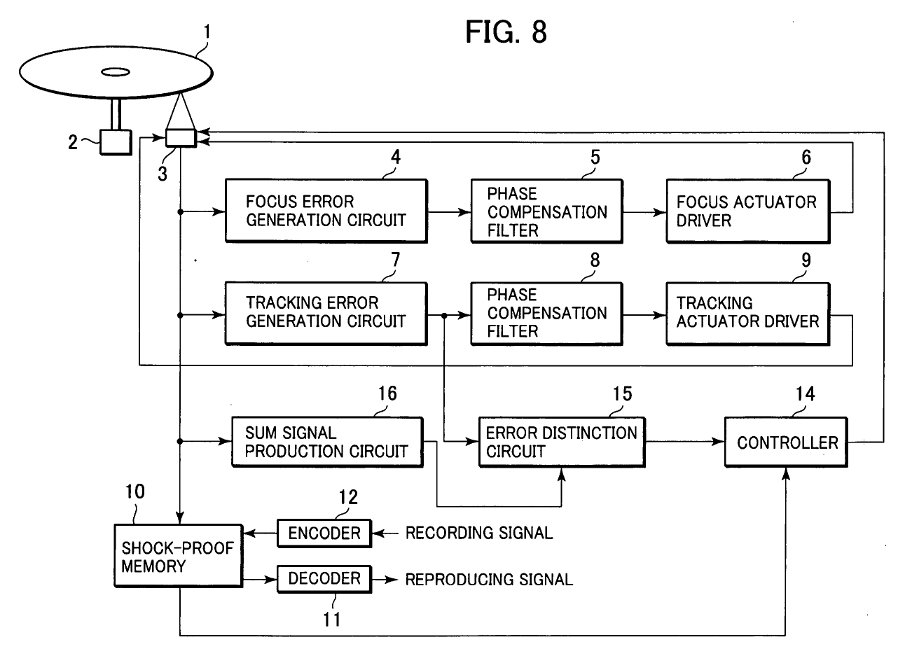

FIG. 8 is a block diagram showing a third embodiment of the present invention. In FIG. 8, blocks having the same functions as those of the conventional apparatus of FIG. 10 and the embodiments of FIGS. 1, 5 are denoted with the same reference numerals. Also in the present embodiment, to record or reproduce data, recording or reproducing data is stored in a shock-proof memory 10. When a recording data amount in the shock-proof memory 10 is not less than a predetermined value, or a reproducing data amount is not more than a predetermined value, a focus tracking control is performed with respect to a desired track in an optical disk 1 to record or read the data with respect to the optical disk 1.

When data is recorded or read with respect to the optical disk 1, both a tracking error signal and a sum signal are input into an error distinction circuit 15. The reference to both the tracking error signal and the sum signal relates to both a de-track amount and a reproducing signal amplitude. In case of detection of a tracking error signal level and a sum signal level at which a recording or reproducing data quality level decreases below a predetermined value, the error distinction circuit 15 outputs a recording/reproducing stop signal to a controller 14. In response to the recording/reproducing stop signal, the controller 14 stops a recording or reading operation with respect to the optical disk 1.

After stopping the recording or reading operation with respect to the optical disk 1, the controller 14 performs a focus tracking control in such a manner as to focus light on a track with respect to which the recording or reading operation has been stopped, and the recording or reading is restarted with respect to the optical disk 1. From when the recording or reading is stopped with respect to the optical disk 1 until it is restarted, the recording data which has been recorded in the optical disk 1 is stored in the shock-proof memory 10. The data which has been read from the optical disk 1 is reproduced using the data stored in the shock-proof memory 10.

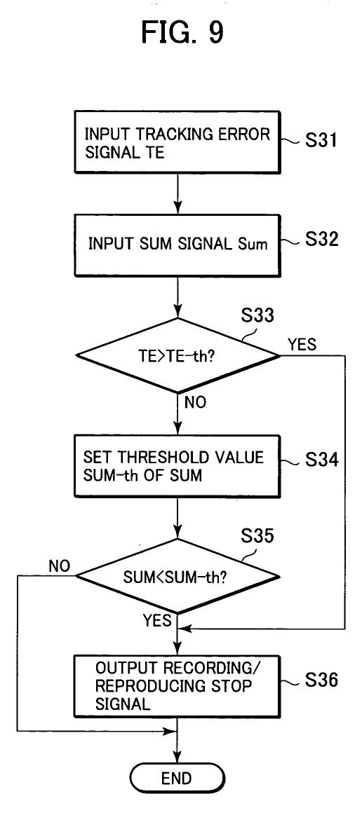

Next, an operation of the error distinction circuit 15 will be described with reference to a flowchart of FIG. 9. First, a tracking error signal TE and a sum signal SUM are input into the error distinction circuit 15 (S31 and S32). Next, a tracking error signal level is compared with a threshold value TE-th (S33). The threshold value TE-th is set to the tracking error signal level to stop the recording/reproducing operation irrespective of a size of a sum signal level, that is, the reproducing signal amplitude.

When the tracking error signal level is not less than TE-th, the error distinction circuit 15 instantaneously outputs a recording/reproducing stop signal to the controller 14 (S36). When the tracking error signal level is less than TE-th, the threshold value SUM-th is set with respect to the sum signal level to interrupt the recording/reproducing operation based on the tracking error signal level (S34). In a method of setting SUM-th, in the same manner as in the second embodiment, when a de-track amount is 40 nm in response to the tracking error signal level, the threshold value SUM-th is set to 1.0 V with respect to the sum signal level. When the de-track amount is 60 nm, SUM-th is set to 0.8 V. In this manner, SUM-th is changed in accordance with the tracking error signal level.

The threshold value SUM-th to be set with respect to the sum signal level based on the tracking error signal level may be calculated by the controller 14, or the threshold value SUM-th of the sum signal level corresponding to the tracking error signal level may be prepared from a table. Next, the sum signal level is compared with the threshold value SUM-th set as described above (S35). At this time, when the sum signal level is not more than SUM-th, the error distinction circuit 15 outputs a recording/reproducing stop signal (S36).

When the signal levels of both the tracking error signal and the sum signal are monitored as in the present embodiment, an appropriate timing to stop the recording/reproducing can be detected. Since the timing to stop the recording/reproducing operation can be exactly detected referring to two signals: the tracking error signal; and the sum signal, the recording/reproducing operation is not uselessly interrupted, and power consumption required for a recovery process for the interruption is not generated.

Furthermore, the apparatus may be constituted in such a manner that the deposition of means for detecting temperature in the optical disk drive, and the calculating or setting of the threshold value with respect to the tracking error signal and the sum signal, is changed in accordance with a detection result of the temperature. Additionally, the apparatus may be constituted in such a manner that the deposition of means for detecting reflectance of the optical disk from the focus or tracking error signal level, and the calculating or setting of the threshold values with respect to the tracking error signal and the sum signal, is changed in accordance with a detection result of the reflectance.

It is to be noted that in the above-described embodiments, the combination of the tracking error signal and the focus error signal, and of the sum signal and the lens position signal, and of the tracking error signal and the sum signal, have been described as examples, but power level values of light beams may be combined to detect the timing to interrupt the recording or reproducing operation. For example, the tracking error signal or the sum signal may be combined with the power level of the light beam. A power level value of the light beam indicates a power level value of a beam for recording during recording, and indicates a power level value of a beam for reproducing during reproducing.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-182531 filed Jun. 21, 2004, which is hereby incorporated by reference herein.

1. An optical information recording/reproducing apparatus which records or reproduces information using a light beam, comprising:
a stopping circuit which outputs a plurality of state detection signals in accordance with an irradiation state of the light beam; and
a circuit which distinguishes deviation from a desired irradiation state of the light beam based on a comparison result of the plurality of state detection signals with a threshold value set with respect to each signal to stop a recording or reproducing operation,
wherein the threshold value set with respect to one state detection signal is set in response to another state detection signal.

2. The apparatus according to claim 1, wherein the state detection signal includes two or more of a tracking error value of the light beam, a focusing error signal, a sum signal level value indicating a sum light quantity of reflected light from the medium, an output value of a position sensor of an objective lens for focusing the light beam on the medium, and a power level value of the light beam.

3. The apparatus according to claim 1, wherein the threshold value set with respect to the state detection signal is calculated in response to another said state detection signal or set referring to a table.

4. The apparatus according to claim 2, wherein the state detection signal indicates the tracking error value and the focusing error value, and the stopping circuit stops the recording or reproducing operation in a case where the focusing error value is not less than a first threshold value set in accordance with the tracking error value.

5. The apparatus according to claim 2, wherein the state detection signal indicates the output value of the lens position sensor and the sum signal level value, and the stopping circuit stops the recording or reproducing operation in a case where the sum signal level value is not more than a second threshold value set in accordance with the output value of the lens position sensor.

6. The apparatus according to claim 2, wherein the state detection signal indicates the sum signal value and the tracking error value, and the stopping circuit stops the recording or reproducing operation in a case where the sum signal level value is not more than a third threshold value set in accordance with a tracking offset value.

7. The apparatus according to claim 1, wherein the set threshold value is further selectively switched based on a difference of temperature in the apparatus or reflectance of the medium.
